(19) United States
(12) Patent Application Publication
(10) Pub. No.: US 2002/0040434 A1
(43) Pub. Date: Apr. 4, 2002

(54) Techniques for providing and obtaining research and development information technology on remote computing resources

(76) Inventors: Keith Elliston, Gaithersburg, MD (US); Gordon Bruce Collier, Fitzroy Harbour (CA)

Correspondence Address: MINTZ LEVIN COHN FERRIS GLOVSKY AND POPEO PC, Suite 400, 11911 Freedom Drive, Reston, VA, 20190, US

(21) Appl. No.: 09/950,006

(22) Filed: Sep. 12, 2001

Related U.S. Application Data
(60) Provisional application No. 60/231,956, filed on Sep. 12, 2000.

(51) Int. Cl. H04K 1/00; H04L 9/00

(52) U.S. Cl. 713/186

(57) ABSTRACT

The present invention describes a novel business model for performing Research and Development Information Technology Application Software Hosting using remote computing resources. A client computer user is provided access to a state-of-the-art remote computing facility and applications running on servers at this remote computing facility, which are secure, environmentally stabilized and properly managed. The computer user's application is available via a secure data line either through a private Intranet link or using encrypted data over the Internet, using a thin-client type environment. This environment can be expanded wherein access to extremely fast processors can be managed by porting the user environment to a fast processor system employing a means that is essentially transparent to the user. The model provides hardware, software and data product installation, maintenance, support, backup and other services for the client.

### FIELD OF THE INVENTION

This invention is directed to providing and obtaining specialized information technology used during research and development, and in particular to the secure access to research and developments applications or data or both in a secured facility from a subscriber computer located remotely from the secure facility,

### BACKGROUND OF THE INVENTION

Information Technology is the distribution and processing of audio, video, digital and other information using computers and telecommunications. Research and Development Information Technology is the same distribution and processing of data focused in Research and Development. State-of-the-art methods for Information Technology have relied on developing local data centers for processing the user applications or using personal computer technology where the applications are installed, managed, controlled and used by the user. This can be performed either on the user's computer system or on a server located near to the user, in the organization s data center.

The field of “Bioinformatics” is the science of biological information management and computation. Recent developments in the field of biotechnology have led to the generation of large masses of data from the laboratory generating DNA sequence, expression and mutation sequence data. Brute force approaches to managing and processing this data are impractical. The field of Bioinformatics entails methods of tracking the data through the laboratory, known as laboratory information management systems (LIMS), methods of acquiring the data and storing it into databases, organizing the data in the databases and giving it another order of organization, extracting the data from the database and finally generating value from this information by producing new information that can only be developed by having the data available for study in this format.

An example of such a bioinformatics approach to a biological problem could be the problem of handling DNA sequence data. A biotechnology enterprise could generate 100,000 to 1,000,000 DNA sequences from 50 to 1000 nucleotides long per month. Examples of such enterprises include Millennium Pharmaceuticals, Inc. (Cambridge, Mass.), Celeres, Inc. (Rockville, Md.), Curagen, Inc. (New Haven, Conn.), Human Genome Sciences, Inc. (Rockville, Md.), The Institute for Genomics Research (TIGR, Rockville, Md.). These and other enterprises can use this data to identify new and novel gene sequences of pharmaceutical interest. DNA sequencing can be performed by the methodology of Sanger (Sanger et al., 1977, Proc. Natl. Acad. Sci. USA, vol 74:5463) or a derivative of this methodology and the products of this approach are separated on a slab gel or run on a capillary electrophoretic device to separate out the fragments. The order of the fragments is related to the DNA sequence, which is the order of Guanine, Adenine, Cytosine or Thymine (also known as G, A, C, or T) in this gene fragment. DNA sequencing is well known to those skilled in the art as exemplified by Alphey, L., 1997, DNA Sequencing: From Experimental Methods to Bioinformatics, Springer-Verlag, New York, N.Y. The next stage is to interpret from either the slab gel or the capillary electrophoretic gel the exact order of the G, A, C, or T bases. The fragments can be labeled radioactively or fluorescently or by other means well known by those skilled in the art. The fragments can either be run side-by-side based on the nucleotide base and how it was labeled and the order is dependent on the size of the fragment or all the bases can be run together and the order is based on the different tags (radiation or fluorescence) that are associated with each base, but separated based on size to give the order of the bases. Computer hardware and software data compilation and digitization means which can convert the electophoretic data into a digital file of the sequence data is commercially available and well known to those skilled in the art. This digitization means converts an analog signal of the band intensities (either from relative fluorescence level or from a digitally scanned autoradiographic film) and generates a computer file consisting of ‘G’, ‘A’, ‘T’, ‘C’ or where there are ambiguous bases the letter ‘N’ or some other letter denoting ambiguity. An example of this digitization means is the software Phred developed at The University of Washington. Other comparable software includes Advanced American Biotechnology (Fullerton, Calif.) DNA Sequence Reading Program (http://www.aabi.com/dnapgae/dna.html), Biosystematica (Devon, UK) Automatic Sequence Reading (http://www.biosystematica.com/genecompar.htm), Bass (The Whitehead Institute for Biomedical Research, Cambridge, Mass.) (http:/www.genome.wi.mit.edu/ftp/distribution/software/Bass/doc/BASS.html#distribution) and Lane Tracking and Base Calling, Perkin-Elmer (Norwalk, Conn.) Neural Net Tracker, Basecaller.

The next stage for the analyst is to take this digital format of the sequence data generated from the laboratory and to analyze the data. Typically those skilled in the art would compare the sequence against other known DNA sequences by using software means such as Blast (Altschul et at., 1990, J. Mol. Biol., vol 215, pp. 403-410) or Smith-Waterman (Smith et al., 1981, J. Mol. Biol., vol 147, pp. 195-197). Other algorithms incorporated into computer programs that are a comparable means of performing sequence similarity are Align (http://www.mips.biochem.mpg.de/mips/programs/align.html) by the Munich Information Center for Protein Sequences (Munich, Germany), DAP from McMaster University (http://www.dess.mcmaster.ca/˜binwu/) and Clustal V (Higgins, D. G. and Sharp, P. M. (1988) CLUSTAL: a package for performing multiple sequence alignments on a microcomputer. Gene 73, 237-244), MSA (Multiple Sequence Alignment) by National Center for Biotechnology Information, National Library of Medicine, SAGA (Sequence Alignment by Genetic Algorithm) (Notredame and Higgins. SAGA: Sequence Alignment by Genetic Algorithm Nucl. Acid. Res. 24:8, 1515-1524 (1996)), SAM (Sequence Alignment and Modeling) by Baskin Center for Computer Engineering and Science University of California, Santa Cruz, Calif. 95064, SIM (Huang, X. and Miller, W. (1991) A Time-Efficient, Linear-Space Local Similarity Algorithm. Advances in Applied Mathematics 12, 337-357. Huang, X., Hardison, R. C. and Miller, W. (1990) A Space-Efficient Algorithm for Local Similarities, Computer Applications in the Biosciences 6, 373-381), GAP (Huang, X. (1994) On Global Sequence Alignment. Computer Applications in the Biosciences 10, 227-235.), NAP (Huang, X. and Zhang, J. (1996) Methods for comparing a DNA sequence with a protein sequence, Computer Applications in the Biosciences 12(6), 497-506.), LAP2 (Zhou, H., Joshi, C, P. and Huang, X. (1997) A local alignment algorithm for comparing a DNA sequence with a protein sequence, in preparation.), GAP2 (Huang, X. (1994) On Global Sequence Alignment. Computer Applications in the Biosciences 10, 227-235.), and other similar software that are available within the academic community. These software means can indicate whether the DNA sequence was already known or at least had similarity to an existing DNA sequence, or that it was a new novel sequence.

Further analysis can be performed on the DNA sequence with analytical software means to determine the protein sequence, protein structure, assemble one or more sequences into one contiguous sequence, search for functional domains, predict the possible biological function and role of the protein. An example of analytical software means that can be used for this is the Genetics Computer Group (Madison, Wis.) suite of software programs which are commercially available. Vector NTI, which includes a suite of analytical software for DNA sequence analysis (Informax, Inc., Rockville, Md.); GeneTool and PepTool as a suite of DNA sequence analysis tools (BioTools, Inc., Edmonton, AB, Canada); and programs available on Internet web sites where individual and groups of software programs are available either for download or can be executed on the web at http://www.oup.co.uk/nar/Volume 27/Issue 01/summmary/gkc105 gml.html, (http.//bioneer.kaist.ac.kr/bionet.html, and Pedro's Molecular Biology web site (http://www.fmi.ch/biology/research tools.html).

The field of Bioinformatics includes the specialties of chemoinformatics, toxicoinformatics and pharmacoinformatics, in addition to the area of genomeinformatics aforementioned above. Pharmacoinformatics includes the area of taking libraries of compounds and testing them against tissue culture cells or non-human animals to determine if they elicit specific enzymatic activities inherent in the disease state they are being targeted to.

Toxicoinformatics is related to pharmacoinformatics in that the toxicity of molecules is tested against tissue culture cells or live organisms. Chemoinformatics is the study of developing new chemicals based on their chemical properties from known chemical data. Software used in the fields of Pharmacoinformatics, Toxicoinformatics and chemoinformatics include the following software packages.

IDBS—ActivityBase

ACDLabs

Aurora

Bioreason

MDL

Spotfire—LDB

MDL—ISIS

OMG—RS3, DIVA

3DP—DD

Tripos

PCOP—MSI

SyData from these experiments can be proprietary to the enterprise performing the experiments, requiring that the information be kept confidential. Using the tools available on the Internet does not provide security and safety, as well as the ability to process the number of samples that are generated. The large number of samples to be processed and the need for secure analysis requires a dedicated Bioinformatics computer facility which is frequently expensive to setup and to maintain due to the environmental and energy requirements, as well as the skilled nature of the personnel.

A typical approach used in the biotechnology and pharmaceutical industry is to build a computer facility that will house the computer systems which run the software and store the acquired data. This computer facility keeps the environmental temperature and humidity, as well as dust tightly controlled. Also, this computer room supplies regulated power to the computers, uninterruptable power systems (UPS) and emergency power in the case of a power failure. Due to the wiring required to connect the terminals and network connections to other computers, the floors are raised and wiring runs under the floor. These rooms are locked and have security systems. These rooms also require several professionally trained system administrators and managers to maintain and support these systems for installing new software, hardware and data products, system backups, load diagnostics and other system diagnostics. This approach to bioinformatics computer support is therefore frequently expensive to setup and to support For smaller scale research and development endeavors the expense to setup and support the personnel, hardware, software and databases makes this a non-optimal or unavailable approach.

### SUMMARY OF THE INVENTION

The present invention provides a method for inexpensively creating the computing resources for a research and development user in an outsourced manner which has a high level of security and functionality.

In an aspect of this invention a cost-effective, secure and properly managed bioinformatics computing facility for biotechnology and pharmaceutical enterprise is provided in a remote location to said enterprise. In a preferred embodiment, management and backup computer hardware system means is provided.

It is another embodiment of the present invention to provide a business model for supporting a bioinformatics computing facility by installing a client computer hardware system means in a centrally located facility with other client computer hardware system means.

Another embodiment of the present invention includes installation, updating and maintenance of software means on said computer hardware system means.

In another embodiment of the present invention the bioinformatics computing facility is connected to said client facility using a high speed secure network means.

In another embodiment the present invention provides for supporting and backing up data on said computer hardware system means.

In accordance with the foregoing, the invention provides a business model for handling several client computer hardware system means with installed software means and data products in a central facility with a secure, environmentally controlled facility, with controlled electrical power means and continuous power means by using uninterruptable power means and emergency power means and in a highly secure building.

In one embodiment of the invention, the client computer hardware system means is maintained to be running almost continuously.

In a preferred embodiment of this invention, the user computer system can be an IBM PC hardware means running Windows, Windows NT or Linux operating system means, a Macintosh hardware means running Macintosh or Linux operating systems means, Silicon Graphics workstation means running UNIX or Linux operating system means, a network computer means or other personal computing work environment means.

In yet another preferred embodiment of this invention, the personal computing work environment means has web browser software means, identity verification software means, Virtual Private Network (VPN) software means installed, as well as personal identity verification hardware means and a communication means.

In yet another highly preferred embodiment of this invention, the browser software means consists of Netscape Navigator (America Online, Inc., Dulles, Va.), Internet Explorer (Microsoft Corp., Seattle, Wash.), Mosaic (University of Illinois), or other computer program means that can read HyperText Markup Language (HTML) documents.

In yet another preferred embodiment of this invention, the identity verification software means and hardware means consists of Security Dynamics (RSA Security, Bedford, Mass.) Smart card and associated smart card reader or key fobs and associated software, Tritheim Technologies (Tarpon Springs, Fla.) smart card, associated smart card reader and software, BioMouse (American Biometric Company, Ottawa, Ontario, Canada) fingerprint reader and associated software, Compaq Computer Corporation (Houston, Tex.) Fingerprint Reader and associated software, Handpunch 2000 (Recognition Systems, Inc., Campbell, Calif.) Hand Geometry reader and associated software, PC Iris (IriScan, Inc., Marlton, N.J.) Iris Scanner and associated software, Certicom smart card (Certicom, Mississauga, ON, Canada) and associated software, as well as other similar devices well known in the art.

In a preferred embodiment of this aspect of the invention, the Virtual Private Network software means is VPNremote™ Client Software for Windows NT (VPN Technologies, Inc.) with their associated VSU-10™ VPN Service Unit. Other VPN solutions are commonly known in the art and are available commercially from Ascend Communications, Inc. (Alameda, Calif.), Aventail Corp (Seattle, Wash.), Axent Technologies, Inc. (Rockville, Md.), Check Point Software Technologies, Inc. (Redwood, Calif.), Compatible Systems (Boulder, Colo.), CyberGuard Corp (Fort Lauderdale, Fla.), Cylink Corp (Sunnyvale, Calif.), Data Fellows Corporation (San Jose, Calif.), Entegrity Solutions (San Jose, Calif.), Entrust Technologies, Ltd. (Ottawa, ON Canada), Fortress Technologies (Tampa, Fla.), GTE Cybertrust (Cambridge, Mass.), Ifsec (New York, N.Y.), Internet Devices, Inc. (Sunnyvale, Calif.), Internet Dynamics, Inc. (Westlake Village, Calif.), Indus River (Acton, Mass.), Information resource Engineering, (IRE) Baltimore, Md.), NetScreen Technologies, Inc. (Santa Clara, Calif.), Network Alchemy, Inc. (Santa Cruz, Calif.), RADGUARD, Inc. (Mahwah, N.J.), Red Creek Communications (Newark, Calif.), Shiva/Intel (Bedford, Mass.), SPYRUS (Santa Clara, Calif.), Time Step Corporation (Kanata, ON Canada), V-ONE Corporation (Germantown, Md.), VPNet Technologies, Inc. (San Jose, Calif.), WatchGuard Technologies, Inc. (Seattle, Wash.), Xedia Corporation (Acton, Mass.).

In a preferred embodiment of this aspect of the invention the said communication means is a connection to the Internet via a dial up phone line, a digital subscriber line, a T-1 connection, a T-3 connection, a satellite connection, cable modem, an ISDN connection, a Synchronous Optical Network (SONET), Asynchronous Transfer Mode (ATM), Optical Connection (OC-3) or similar communications link connecting the users computer to communicate over the Internet.

In a preferred embodiment of this aspect of the invention the said communication means is a frame-relay connection which can have speeds from 56 Kbps to T-3 speeds, direct phone line connections from 56 Kbps to T-3 speeds, long distance phone line connections from 56 Kbps to T-3 speeds, or any combination of these over a public or private connection.

In a preferred embodiment of this aspect of the invention the said computer hardware means is a computer system that serves as a computer server for bioinformatics software means. Especially preferred computer hardware system means in this aspect of the invention are the Silicon Graphics Origin 200 (Silicon Graphics, Mountain View, Calif.), Sun computer server (Sun Microsystems, Palo Alto, Calif.), Digital Equipment Corporation Alpha Server (Compaq, Houston, Tex.), Dell Server (Dell Computer, Round Rock, Tex.) or other computer systems that perform bioinformatics software computation.

In another preferred embodiment of this aspect of the invention the said computer software means is software that provides bioinformatics applications. Especially preferred software means in this aspect of the invention are the University of Wisconsin Genetics Computer Group software (Madison, Wis.), SwissProt (Geneva Biosciences, Geneva, Switzerland), Sequence Retrieval Software and BioScout (Lion Bioscience, Inc., Heidelberg, Germany). Additional preferred software is commonly known in the art and available from:

Compugen

Incyte—Lifetools

Genomica

Genomyx—Grail

Pangea—Gene World

Netgenics—Synergy

Neomorphic

MAG

Informax—Vector NtiIn yet another preferred embodiment of this invention the computer user accesses a high performance computer means for a limited time period. This is advantageous because a powerful computing system is available on a temporary basis, without the requirement of purchasing the expensive equipment. These types of computing capabilities are not presently available on a temporary basis. A high performance computer could consist of a Compugen (Jamesburg, N.J.) Bio XL/P Bioaccelerator, Paracel (Pasadena, Calif.) GeneMatcher, Time Logic (Incline Village, Nev.) DeCypher, Cray (Silicon Graphics, Mountain View, Calif.)) SVI, Beowulf Cluster (DHPC Technical Report DHPC-061, Published in Proc. of the 6th IDEA Workshop, Rutherglen, January 1999., Beowulf—A New Hope for Parallel Computing?, K. A. Hawick, D. A. Grove and F. A. Vaughan, January 1999.), IBM Mainframe computer.

### BRIEF DESCRIPTION OF THE FIGURES

FIG. 1: A block diagram of a computer system suitable for connection to a network and executing research and development applications according to one embodiment of the present invention.

FIG. 2: An exemplary overview of a user's internal computer facility.

FIG. 3. A block diagram of a design for remote secured application and data hosting on an network according to one embodiment of the present invention.

FIG. 4. A block diagram of a design for remote secured application and data hosting on an network according to another embodiment of the present invention.

### DETAILED DESCRIPTION OF THE INVENTION

It has been discovered that an inexpensive approach to installing, supporting and maintaining research and development information technology hardware and software means for biotechnology and pharmaceutical enterprises can be effected by placing multiple client computer hardware system means into one centrally located secure facility that provides the optimal computer environment and safety, as well as the sharing of personnel with specific skill sets amongst the various client computer hardware system means.

The user of the service uses a personal computer means that functions in a thin-client environment, wherein the computing functions are performed on a remote computer server means and the specialized functions of the application software means specific to the user including keystrokes, mouse-clicks, device activations, screen refreshes are performed on the local computer device. This functionality can be provided by using a variety of internet software means including web-browser application, java application, thin client environment software package or a specialized application specific for the computer hardware on the users personal computer means.

The user connects from their personal computer means, through a communications means to the remote data center. This connection can be performed using a private or public communications means.

The remote computer systems are placed into a well managed, highly secure data center with multiply redundant systems to avoid any system down-time due to unavoidable accidents.

Further, the remote computer system means are managed locally or remotely using the highly secure back-channel firewall protected network connection means.

For the computer user, they have a highly secure computer server means with both physical and logical connections to work on which is specific to them or their enterprise, avoiding any cross contamination of data. In this business model, the user or user enterprise is invoiced for monthly computer time on the server means, as well as additional per month charges for specific computer application means they use.

The description which follows is exemplary. However, it should be clearly understood that the present invention may be practiced without the specific details described herein. Well known structures and devices are shown in block diagram form in order to avoid unnecessarily obscuring the present invention.

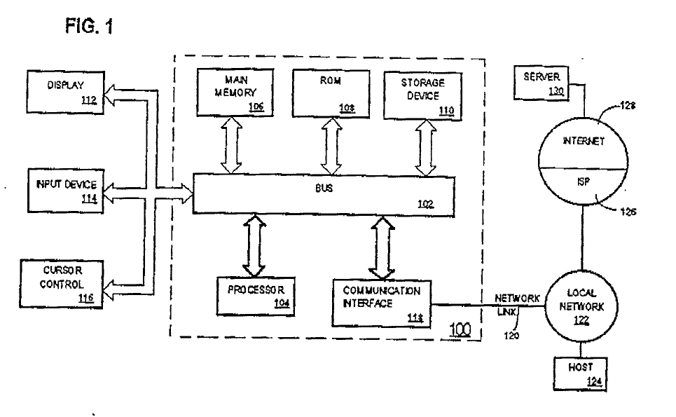

At least portions of the invention arc intended to be implemented on or over a network such as the Internet. An example of a computer attached to such a network is described in FIG. 1.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

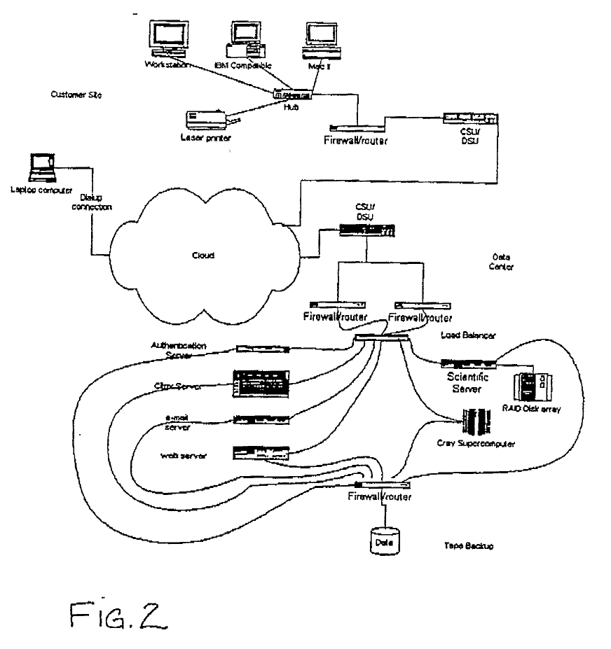

FIG. 2 shows an exemplary overview of a user's internal computer facility using any personal computer means with a secure method of user authentication means, networking hardware means (CSU/DSU, router, hub, firewall) to securely connect the internal network to the external network, connection to a cloud means (Internet, X-25, frame-relay), data center networking hardware means (CSU/DSU, router, hub, firewall), specialized server computer means, high speed specialized application computer means (high performance computers), a back-channel networking hardware connection means to allow secure management of the data center computers.

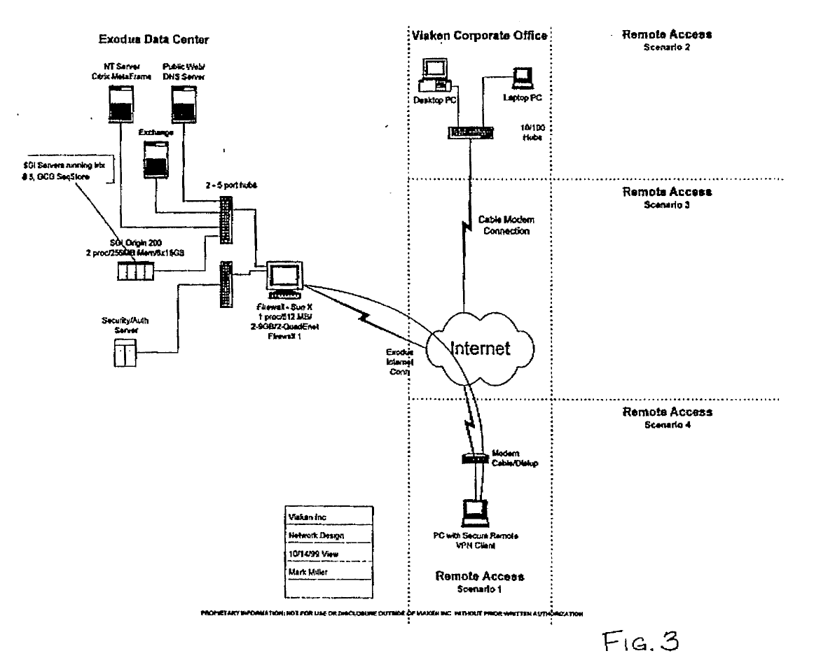

FIG. 3 shows a network design diagram according to one embodiment of the present invention which includes an NT Server (Citrix Metaframe). The company Citrix makes a software product called Metaframe (www.citrix.com) which allows multiple users to log onto an NT server. The NT server has applications which normally run on the Window 95/98 environment. The key aspect of this technology is what they refer to as ICA (Independent Computing Architecture). ICA allows an NT server to run an application, let's say Microsoft Word. A user can connect to the NT server through a local, wide area network or dial-up connection and run Word from the NT server. ICA only transfers back and forth along the communications channel the screen refreshes, keystrokes and mouse clicks, which reduces the necessary bandwidth. From the users aspect, it looks like Word is running locally on their PC, but in reality it's running on an optimized remote NT server which gives improved performance. Further, the user does not need to have an NT device to run the application. The user can use a Macintosh, Unix or legacy (old slow PC) and get excellent performance for running Word by installing a machine specific client program that understands the information that ICA uses.

Microsoft Word is what would be referred to as a “Fat Client.” For Viaken's business, many of the existing Bioinformatics programs are what would be considered to be a “Fat Client.” By installing these Bioinformatics programs in a Citrix environment, Viaken offers a unique opportunity for a user client to be able to run these programs from mac, unix and legacy PC machines. This environment allows for either an entire screen (window) with an entire NT environment to show up, or for an icon with a single application to be placed onto the users screen in their existing window environment.

Public Web/DNS Server This Linux (Red Hat 6.0) server is used to host Viaken's public web site and also serves as a DNS server. (A DNS (Domain Name Server) server functions as a translator. It converts the URL name, e.g. www.yahoo.com to a numeric representation, e.g., 216.33.16.54 [not the actual number])

Exchange Server. This NT server is used to run Microsoft Exchange applications, e.g. e-mail applications.

SGI Origin 200. This Silicon Graphics computer server is used to run the BioInformatics applications. For example, the database Oracle and the Genetics Computer Group (GCG) BioInformatics application runs on this server.

Security/Authorization Server is an NT server which runs Security Dynamics software product, Ace, which is used to authenticate users using Smart Cards and their associated Smart Cards or the key fobs. Firewall—SunX. This machine is used as a Firewall to prevent users from outside having unauthorized access to the Exodus Data Center network.

Viaken Corporate Office has a Desktop PC and Laptop PC. The applications running at the Exodus Data Center are run on the Desktop and Laptop PCs at Viaken's Corporate Office. Presently, the connection to the Datacenter is through a cable modern connection through the Internet, but this could easily be through a Digital Subscriber Line (DSL), T-1, T-3, ISDN or other high bandwidth connection. This figure shows a 10/100 BaseT Ethernet hub, but is missing the Linux router which runs IP address masquerading.

Remote Access Scenario 4 is supposed to be a customer site. This site would be similar to the Viaken Corporate Office, and would contain a firewall, a router, a hub, an ethernet network and PCs and Laptop computers.

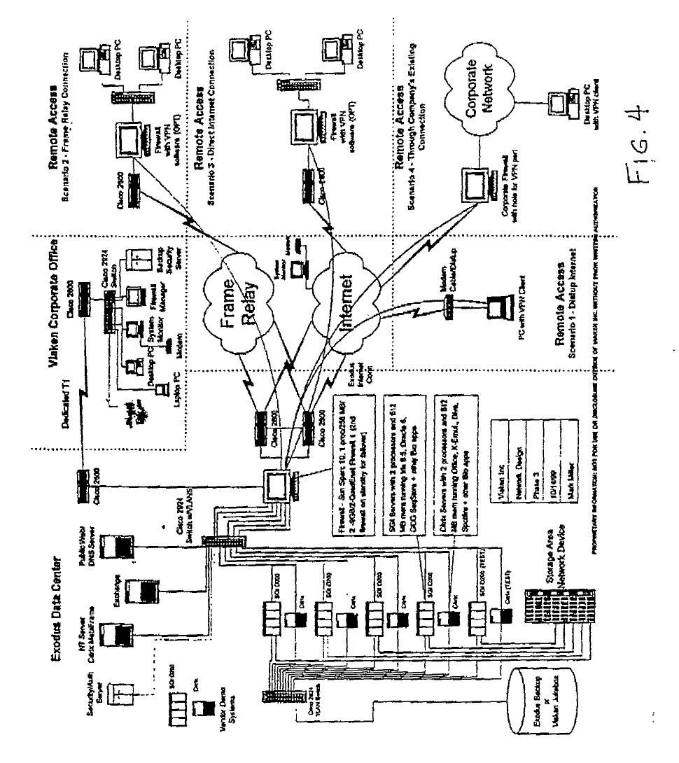

FIG. 4 shows a Network Design for another embodiment. This embodiment contains the same equipment mentioned above plus additional equipment. The additional equipment includes a Vendor Demo System which is a Citrix/Metaframe machine setup to run the applications that our vendors might want to run. Cisco 2924 Switch is a particular switch. Cisco 2600 Router is a particular router. Storage Area Network Device is a networkable storage device like that sold like Pathlight (www.pathlight.com). Exodus Backup or Viaken Jukebox is a tape based backup device Which is used in Viaken's data center in their backchannel switch to protect cross access between customers.

Viaken Corporate Office includes a suite of computers. The Firewall Manager is a computer used to manage the firewall systems at the Exodus Data Center, and potentially at other customer sites. System Monitor with modem is used to connect outside the dedicated T1 connection to the Viaken set of severs at the Exodus Data Center, a computer is setup with a number of system monitor programs that will test that the systems are up and running (e.g., the “Ping” program or more sophisticated monitoring programs). A Test Environment is to allow future computer hardware and software to be installed and tested out to determine its compatibility with the existing Viaken architecture. A Backup Security Server will be used to perform local backups on-site at the Viaken Corporate Office, which allows extra redundancy.

Remote Access (Scenario 1, 2, 3 and 4) includes a bunch of computers with a router. VPN client software runs on the client machines. In Scenarios 2-4, the client network uses a corporate firewall. Scenario 1 connects with a Cable Modem. Scenario 2 connects via a frame relay connection. Scenarios 3 and 4 connect via the Internet. Attached to the Internet, the system monitor and modem perform the same functions as the system monitor at the corporate headquarters.

### Operation of the Secure Facility

A new customer orders their service: We generate a list of software options within the fields of Genome Informatics, Pharmaco Informatics (High Throughput Screening), Chem Informatics (drug design), and Office Automation. We are presently working on an ordering form, but right now the customer just needs to let us know which applications they want.

The applications may include the following in several categories. Genome Informatics include Genetics Computer Group (GCG) SeqWeb, SeqStore, SeqLab, along with Nucleotide, Protein, EST and Patent databases. Informax, Inc. is Software Solution for Bio-Medicine. PharmacoInformatics: include Oxford Molecular Group, Inc.—DIVA application. Spotfire—Spotfire Pro. Chem Informatics include Oxford Molecular Group—RS3. Office Applications include Microsoft Word, Excel, Powerpoint optionally Microsoft Access, Frontpage, Vision Professional, Outlook, for example.

The customer chooses the software they want to use from a menu list, they choose if they want a high bandwidth connection (DSL, T-1, T-3, ISDN, etc.), how many users they will have, if they want additional training. Once the user picks the options they want, the user waits about 2 to 6 weeks (longer if a high bandwith solution needs to be put in place) and the service shows up on their system.

Viaken is responsible for taking care of all of the software licenses. Viaken will install the software onto the appropriate hardware platform. Viaken takes care of the hardware. Where it doesn't matter, software may be placed onto one of several Unix based platforms, based on cost and performance. For the user data, we will need to learn what form of backup device is available and port the data using that format. Now, in the advent of the Internet, we can setup a VPN session with the server which contains the data and port it onto our servers. Viaken presently has 100 Mbps connectivity to the Internet (upgradeable to 1 Gbps), and the client network connection is the limiting factor.

High bandwidth solutions can be obtained from MCI WorldCom, for example, who can be called up to install the customers solution wherever in the world. (This choice is based on several months of discussions and negotiations with several high bandwidth providers). Viaken has also worked with FlashCom on DSL solutions. Direct Metro T-1 connections can be provided with Bell Atlantic locally.

The bottom line is that the customer chooses from a list and Viaken implements it. The client then waits a few weeks and the solution is implemented. If the customer wants something novel, then we decide if we try to implement the solution or perform consulting services.

User Logon Procedure: [assuming the user is connected to their internal network. If the user is remotely connected, such as when they dial in, then they should perform a connection to their ISP provider first]. For non-Citrix/Metaframe applications: User connects to application using a web browser using a unique IP address which points to their unique server. The firewall first authenticates the user, using the Secure ID software. Once authenticated, the user is permitted through the firewall to the server. The data is now encrypted with 128-bit triple-DES encryption using a Virtual Private Network (VPN) connection. (N.B.—Checkpoint uses their own proprietary encryption algorithm FWZ-1 which is similar to DES for VPN) The PKI keys to setup this level of encryption is based on 1024-bit encryption. Again, this means that the user first sets up a VPN connection from their network (or from their PC if they are running VPN client software) to the Viaken firewall. All data from the user to the firewall is encrypted and protected. The user now connects to the server. Each server additionally authenticates the user, using a user and password process.

Citrix/Metaframe applications: The user can setup the network link as above with VPN encryption. The user then runs the Metaframe client, which requires another user name, password and server doman. The Citrix/Metaframe uses its own 128-bit triple DES encryption with 1024-bit RSA PKI keys.

Running Applications: The users use the applications as if the applications were on a local network. They can start and stop them as if they were on the local network. The data can be stored remotely on the server or transferred locally to the user. Whatever the user wants for their particular application. Within a VPN session, all of the data is protected in both directions.

For using the High Performance Computing resources, the user will be setup with an account. Initially, we plan that only one company can use the computer at a time. The user will logon to the server, just like any other server in the Viaken system with a user name and password.

### Sources of Personal Computer Hardware and Operating Systems

Personal computer can include the Intel processor (Intel Corporation, Santa Clara, Calif.) based computer hardware platform and the Windows family (Microsoft Corporation, Seattle, Wash.) or Linux (Redhat Linux, Durham, N.C.) operating systems, MacIntosh (Apple Computer, Inc., Cupertino, Calif.) hardware platform running the MacIntosh or Linux operating systems, Silicon Graphics computers (Silicon Graphics, Mountain View, Calif.) running UNIX or LINUX operating systems or other user computer system allowing the user to connect to the remote data center and run the thin-client application software.

### Sources of User Authentication Hardware/Software

The user identity verification software and hardware can use the Security Dynamics (RSA Security, Bedford, Mass.) Smart card and associated smart card reader or key fobs and associated software, Tritheim Technologies (Tarpon Springs, Fla.) smart card, associated smart card reader and software, BioMouse (American Biometric Company, Ottawa, Ontario, Canada) fingerprint reader and associated software, Compaq Computer Corporation (Houston, Tex.) Fingerprint Reader and associated software, Handpunch 2000 (Recognition Systems, Inc., Campbell, Calif.) Hand Geometry reader and associated software, PC Iris (IriScan, Inc., Marton, N.J.) Iris Scanner and associated software, Certicom smart card (Certicom, Mississauga, ON, Canada) and associated software, as well as other similar ar devices well known in the art.

### Sources of Virtual Private Network (VPN) Hardware/Software

The Virtual Private Network software can be chosen from VPNremote™ Client Software for Windows NT (VPNet Technologies, Inc.) with their associated VSU-10™ VPN Service Unit, or any other suitable Virtual Private Network software.

### Sources of Computer Server Hardware

The computer server hardware can be chosen from the list consisting of the Silicon Graphics Origin 200 (Silicon Graphics, Mountain View, Calif.), Sun computer server (Sun Microsystems, Palo Alto, Calif.), Digital Equipment Corporation Alpha Server (Compaq, Houston, Tex.), Dell Server (Dell Computer, Round Rock, Tex.) or other computer systems that perform computation in a server environment.

### Sources of Secure Computer Facilities

The co-location facility, a secure managed data center can be chosen from the list consisting of Exodus Communications, Inc. (Santa Clara, Calif.), AboveNet Communications, Inc. (Vienna, Va.), NaviSite, Inc. (Andover, Mass.) or similar data center well known to those skilled in the art.

### Sources of Fast Communication Links

The communication link used in this invention can be chosen from the list consisting of a connection to the Internet via a dial up phone line, a digital subscriber line, a T1-connection, a T-3 connection, a satellite connection, cable modem, an ISDN, a Synchronous Optical Network (SONET), Asynchronous Transfer Mode (ATM) connection, Optical Connection (e.g. OC-3) connection or other suitable communications link connecting the user's computer to communicate over the Internet.

Other sources of said communication link is a frame-relay connection which can have speeds from 56 Kbps to T-3 speeds, direct phone line connections from 56 Kbps to T-3 speeds, long distance phone line connections from 56 Kbps to T-3 speeds, or any combination of these over a public or private connection.

Other sources of said fast communication links can consist of X.25 connections.

### Sources of Web Based Browsers

Source of web based browsers for this invention consists of Netscape Navigator (America Online, Inc., Dulles, Va.), Internet Explorer (Microsoft Corp., Seattle, Wash.), Mosaic (University of Illinois), or other computer program that can read HyperText Markup Language (HTML) documents.

### Sources of Thin-Client Enabling Software

Sources of thin-client enabling software include Citrix, Inc. (Fort Lauderdale, Fla.) Metaframe and Microsoft Windows NT Server Terminal Server Edition (Microsoft Corp, Seattle, Wash.) and other providers of thin-client enabling software.

### EXAMPLE I

### Bioinformatics Remote Computing Business Model Using an Internet Communications Link

A bioinformatics user uses a Hewlett-Packard (Palo Alto, Calif.) Pavillion model 4458 computer and model S50 monitor running Windows 98 operating system, connected to an internal Ethernet network via a D-Link (Irvine, Calif.) model D-8 hub connected to a router (a Compaq (Houston, Tex.) model Prolinea 466 computer running Redhat Linux (Durham, N.C.) operating system configured as a router), which is in turn connected to a Com21 (Milpitas, Calif.) Cable Modem. The uplink is provided by a 56 Kbps Viking (Rancho Santa Margarita, Calif.) modem. The Hewlett-Packard model 4458 computer has a GemPlus (Redwood City, Calif.) model GCR410 smart card reader connected to the serial port of the computer. The associated software for the smart card reader is installed on the computer. Internet Explorer (Microsoft Corp., Seattle, Wash.) version 5.0 and Cisco Checkpoint client VPN software is installed on the computer.

The Cable Modem connects the user's computer to the Internet which permits connection to the servers at the Exodus Communications data center.

In the data center, the Internet connection is connected to a Cisco (San Jose, Calif.) model 2501 router, which is in turn connected to a Sun Ultra 10 Server with quad Ethernet and running Cisco Checkpoint Firewall 1 software. This in turn is connected to a Cisco model 2948 switch, which is connected to a Silicon Graphics model 200 server running Irix 6.5 operating system and the Genetics Computer Group suite of bioinformatics software, including the thin-client browser enabled software for GCG, SeqWeb. Another Dell model PowerEdge 1300 server running Windows NT 4.0 with ACE Authorization software (RSA Security, Inc.) for the smart card readers is connected to the switch.

The user first runs the Virtual Private Network (VPN) software client and logs onto the system. The user connects to the bioinformatics software via the web browser by first confirming their ability to connect to the server by inducing the authorization software which uses the smart card authorization based on accessing information off of the smart card placed into the smart card reader. The user can then access their server for that session and run the bioinformatics software. The user is charged a monthly fee for accessing this service.

### EXAMPLE 2

### Bioinformatics Remote Computing Business Model Using a Frame Relay Communication Link

A bioinformatics user using a Hewlett-Packard (Palo Alto, Calif.) Pavillion model 4458 computer and model S50 monitor running Windows 98 operating system, connected to an internal Ethernet network via a D-Link (Irvine, Calif.) model D-8 hub connected to a CSU/DSU router (ROUTERMATE-T1 T1/FT-1 CSU/DSU 1-V.35 SNMP/TELNET OR V100 MNG (OSICOM TECHNOLOGIES INC., Santa Monica Calif.), which is in turn connected to a T-1 Frame relay connection. The Hewlett-Packard model 4458 computer has a GemPlus (Redwood City, Calif.) model GCR410 smart card reader connected to the serial port of the computer. The associated software for the smart card reader is installed on the computer. Internet Explorer (Microsoft Corp., Seattle, Wash.) version 5.0 and Cisco Checkpoint client VPN software is installed on the computer.

The T-1 connection at the data center is connected to a CSU/DSU router (ROUTRMATE-T1 T1/FT-1 CSU/DSU 1-V.35 SNMP/TELNET OR V100 MNG (OSICOM TECHNOLOGIES INC., Santa Monica, Calif.).

In the data center, the CSU/DSU connection is connected via a 100 Mbs Ethernet connection to a Cisco (San Jose, Calif.) model 2501 router, which is in turn connected to a Sun Ultra 10 Server with quad Ethernet and running Cisco Checkpoint Firewall 1 software. This in turn is connected to a Cisco model 2948 switch, which is connected to a Silicon Graphics model 200 server running Irix 6.5 operating system and the Genetics Computer Group suite of bioinformatics software, including the thin-client browser enabled software for GCG, SeqWeb. Another Dell model PowerEdge 1300 server running Windows NT 4.0 with ACE Authorization software (RSA Security, Inc.) for the smart card readers is connected to the switch.

The user first runs the Virtual Private Network (VPN) software client and logs onto the system. The user connects to the bioinformatics software via the web browser by first confirming their ability to connect to the server by inducing the authorization software which uses the smart card authorization based on accessing information off of the smart card placed into the smart card reader. The user can then access their server for that session and run the bioinformatics software.

The user is charged a monthly fee for accessing this service.

### REFERENCES

Sanger et al., 1977, Proc. Natl. Acad. Sci. USA, vol 74:5463

Alphey, L., 1997, DNA Sequencing: From Experimental Methods to Bioinformatics, Springer-Verlag, New York, N.Y.

Altschul et al., 1990, J. Mol. Biol., vol 215, pp, 403-410

Smith et al., 1981, J. Mol. Biol., vol 147, pp. 195-197

DHPC Technical Report DHPC-061, Published in Proc. of the 6th IDEA Workshop, Rutherglen, January 1999.,

Beowulf—A New Hope for Parallel Computing?, K. A. Hawick, D. A. Grove and F. A. Vaughan, January 1999

### Sample Client Services

Sample products that can be offered according to the present invention includes those described on the attached pages following the Figures.

1. A business model for research and development remote information technology computing comprising:
(a) Installing a client computer hardware system in a centrally located facility with other client computer systems,
(b) Installing client software onto said computer hardware system,
(c) Connecting said computer hardware system to a fast secure network link,
(d) Maintaining and supporting said computer hardware system,
(e) Permitting the client to have secure access to said computer hardware system over a fast secure network link,
(f) Performing nightly backups of data on said computer hardware system.

2. A business model according to claim 1 wherein said client does not have to create their own computer room facilities.

3. A business model according to claim 1 wherein said client has a continuously running computer system.

4. A business model according to claim 1 wherein the said computer hardware can be selected from the group consisting of a Silicon Graphics Origin 200, Sun computer, Digital Equipment Corporation Alpha Server, and Dell.

5. A business model according to claim l wherein the said computer software and data products can be selected from the group consisting of the University of Wisconsin Genetics Computer Group software, SwissProt, Sequence Retrieval Software.

6. A business model according to claim 1 wherein the fast network link can be selected from the group of T1, T3, Digital Subscriber Line, Satellite modem, Cable Modem, 56 Kbps modem, ISDN connected to the Internet.

7. A business model according to claim 1 wherein the fast network link can be selected from the group of T1, T3, Digital Subscriber Line, Satellite modem, Cable Modem, 56 Kbps modem, ISDN connected to a frame relay connection.

8. A business model according to claim 1 wherein the fast network link can be selected from the group of T1, T3, Digital Subscriber Line, Satellite modem, Cable Modem, 56 Kbps modem, ISDN connected to an X.25 connection.

9. A business model according to claim 1 wherein the fast network link can be selected from the group of T1, T3, Digital Subscriber Line, Satellite modem, Cable Modem, 56 Kbps modem, ISDN connected to an ATM connection.

10. A business model according to claim 1 wherein the user authorization is performed using smart cards, key fobs, fingerprint or iris biometrics, chosen from the list Security Dynamics Smart card Tritheim Technologies smart card, Compaq Computer Corporation Fingerprint Reader, Handpunch 2000 Hand Geometry, PC Iris, Iris Scanner, Certicom smart card.

11. A business model according to claim 1 wherein the client accesses said computer hardware system selected from the group of NetScape Communicator, Netscape Navigator, Mosaic, Internet Explorer.

12. A business model according to claim 1 wherein the client accesses said computer hardware system in a secure fashion using Virtual Private Network client software chosen from the list of (need to work on list).

13. A business model according to claim 1 wherein the thin-client environment for the user is created using Citrix, Inc. Metaframe and Microsoft Windows NT Server Terminal Server Edition.

14. A business model according to claim 1 wherein the High Performance Computing Systems is chosen from the list consisting of Compugen Bio XL/P Bioaccelerator, Paracel GeneMatcher, Time Logic DeCypher, Cray SVI, IBM mainframe or Beowulf cluster.

15. A method for providing secure information processing resources at a secure facility controlled by a service provider to a plurality of subscribers, the information processing resources including a plurality of software applications controlled by the service provider and computer system resources, the computer system resources including a plurality of processors and a plurality of computer readable medium devices, the method comprising:
establishing the secure facility controlled by the service provider;
providing secure access to the secure facility over a network for the plurality of subscribers that excludes non-subscribers, wherein at least one subscriber is located at a remote site controlled by the at least one subscriber;
prompting a particular subscriber among the plurality of subscribers to select a particular software application among the plurality of software applications;
providing an interface that enables the particular subscriber to execute the particular software application using a particular portion of the computer system resources; and
excluding other subscribers of the plurality of subscribers from the particular portion of the computer system resources being used.

16. A method for providing secure information processing resources at a secure facility controlled by a service provider to a plurality of subscribers, the information processing resources including a plurality of software applications controlled by the service provider and computer system resources, the computer system resources including a plurality of processors and a plurality of computer readable medium devices, the method comprising:
providing secure access to the secure facility over a network for the plurality of subscribers that excludes non-subscribers, wherein at least one subscriber is located at a remote site controlled by the at least one subscriber;
providing an interface that enables a particular subscriber among the plurality of subscribers to execute a particular software application among the plurality of software applications using a particular portion of the computer system resources; and
excluding other subscribers of the plurality of subscribers from the particular portion of the computer system resources being used.

17. A method of obtaining secure information processing resources at a secure facility controlled by a service provider for a plurality of subscribers, the information processing resources including a plurality of software applications controlled by the service provider and computer system resources, the computer system resources including a plurality of processors and a plurality of computer readable medium devices, the method comprising:
securely accessing the secure facility over a network by a particular subscriber among the plurality of subscribers, from a remote site controlled by the particular subscriber; and
sending signals over the network causing a particular software application among the plurality of software applications controlled by the service provider to be executed using a particular portion of the computer system resources at the secure facility, wherein other subscribers among the plurality of subscribers are excluded from the particular portion of the computer resources.

18. A system for providing secure information processing resources by a service provider to a plurality of subscribers, the system comprising:
a network;
a secure facility controlled by the service provider; and
computer resources located in the secure facility including
a memory medium for storing a plurality of software applications controlled by the provider and for storing data belonging to the plurality of subscribers,
a communications channel connected to the network for providing secure access to the computer resources for the plurality of subscribers, wherein at least one subscriber of the plurality of subscribers is located at a remote site, and
one or more processors configured for receiving signals from a particular subscriber among the plurality of subscribers over the communications channel, for executing a particular software application of the plurality of software applications using a particular portion of the computer system resources in response to the signals from the particular subscriber, and for excluding other subscribers of the plurality of subscribers from the particular portion of the computer system resources being used.

19. A computer program product for providing secure information processing resources at a secure facility controlled by a service provider to a plurality of subscribers, the information processing resources including a plurality of software applications controlled by the service provider and computer system resources, the computer system resources including a plurality of processors and a plurality of computer readable medium devices, the computer program product comprising:
a computer readable medium,
instructions stored on the computer readable medium for causing one or more processors in the secure facility to receive signals from a particular subscriber among the plurality of subscribers over a communications channel, to execute a particular software application of a plurality of software applications controlled by the service provider using a portion of computer resources at the secure facility in response to the signals from the particular subscriber, and to exclude other subscribers among the plurality of subscribers from the particular portion of the computer resources.

20. A computer program product for obtaining information processing resources at a secure facility controlled by a service provider for a plurality of subscribers, the information processing resources including a plurality of software applications controlled by the service provider and computer system resources, the computer system resources including a plurality of processors and a plurality of computer readable medium devices, the computer program product comprising:
a computer readable medium; and
instructions stored on the computer readable medium for causing one or more processors, at a subscriber site controlled by a particular subscriber among the plurality of subscribers, to securely access over a network the secure facility remote from the subscriber site, and to provide signals for executing a particular software application among the plurality of software applications using a particular portion of the computer resources, wherein other subscribers among the plurality of subscribers are excluded from the particular portion of the computer resources used.
